(19) United States
(12) Patent Application Publication
(10) Pub. No.: US 2009/0056579 A1
(43) Pub. Date: Mar. 5, 2009

(54) Print substrate-contacting element having an ink-repellent coating and method for coating a print substrate-contacting element

(75) Inventors: Bertold Gruetzmacher, Schriesheim (DE); Martin Gutfleisch, Dossenheim (DE); Gerald Erik Hauptmann, Bammental (DE); Gerhard Peiter, Viernheim (DE)

Correspondence Address: Davidson, Davidson & Kappel, LLC, 485 7th Avenue, 14th Floor, New York, NY, 10018, US

(73) Assignee: Heidelberger Druckmaschinen AG, Heidelberg (DE)

(21) Appl. No.: 12/288,980

(22) Filed: Oct. 25, 2008

Related U.S. Application Data
(62) Division of application No. 10/655,928, filed on Sep. 5, 2003, now abandoned.
(60) Provisional application No. 60/411,654, filed on Sep. 18, 2002.

(30) Foreign Application Priority Data
Sep. 9, 2002 (DE) 102 41 671.0

(51) Int. Cl. B41N 1/00; B41N 3/03

(52) U.S. Cl. 101/453; 101/465

(57) ABSTRACT

A print substrate-contacting element having an ink-repellent coating on a surface of a microstructured carrier is described, the coating including at least one derivative of an amphiphilic organic compound whose polar region has an acidic character. A method for coating a surface of a microstructured carrier of a print substrate-contacting element is distinguished by the application of an amount of substance, which includes at least one derivative of an amphiphilic organic compound whose polar region has an acidic character, by treating the surface with an alcoholic solution of the amount of substance. The print substrate-contacting element can very advantageously be the surface of a back-pressure cylinder in a print substrate-processing machine, in particular in a printing press. The coating method can be carried out in a print substrate-processing machine.

This application is a continuation of U.S. patent application Ser. No. 10/655,928 filed Sep. 5, 2003 and hereby incorporated by reference herein. Priority to German Patent Application 102 41 671.0, filed Sep. 9, 2002 and hereby incorporated by reference herein, and to U.S. Provisional Patent Application No. 60/411,654, filed Sep. 18, 2002 and hereby incorporated by reference herein, is claimed.

### BACKGROUND INFORMATION

The present invention is directed to a print substrate-contacting element having an ink-repellent coating on a surface of a microstructured carrier. The present invention is also directed to a method for coating a surface of a microstructured carrier of a print substrate-contacting element.

On its path through a print substrate-processing machine, a print substrate is contacted by various elements, such as cylinders, grippers, conveyor belts, carrier rollers, transfer rollers, stop means, guides or the like. There are numerous reasons for these contacting operations: For example, the need arises to fix the position or the state of motion of the print substrate, or accelerate or decelerate the velocity of the print substrate along the path, or press at least one portion of the surface of the print substrate against a surface. For the reasons delineated here or for various other reasons, it may be necessary to contact the print substrate at one location or at one part of its surface where printing ink is found, in particular recently applied printing ink. In addition, because of the geometry or the functioning method of the print substrate-processing machine, at its location or surface where it contacts a print substrate at a particular point in time, a print substrate-contacting element can come into contact at another point in time with other elements bearing printing ink, especially printing ink that is still fresh. For that reason, it is necessary to prevent printing ink from being deposited at the contacting point or surface of the print substrate-contacting element.

The difficulty described here is especially relevant for back-pressure cylinders in print units of print substrate-processing machines. In direct planographic printing, the dynamic effect of a back-pressure cylinder (also referred to as impression cylinder) presses the print substrate against a printing-form cylinder and, in indirect planographic printing, respectively, against a blanket cylinder (also referred to as transfer printing cylinder). In particular, the planographic method can be an offset printing method or a waterless offset printing method. In this context, the back-pressure cylinder contacts the print substrate at least in the printing nip from the side facing away from the printing-form cylinder or blanket cylinder. This turned-away side can already be ink-bearing, for example when printing has been carried out in a print unit situated upstream, along the path of the print substrate through the print-substrate processing machine. This situation arises, in particular, in the context of so-called second-side printing in sheet-processing printing presses. In addition, the back-pressure cylinder can also be in contact with the printing-form cylinder or blanket cylinder, which, in some instances, carries printing ink, when no print substrate is situated in the printing nip.

Numerous concepts have already been introduced with regard to how to design the surfaces of print substrate-contacting elements to prevent the print substrate-contacting elements, as well as the print substrates themselves from being smeared with printing ink. The introductory part of the specification of German Patent Application No. 101 15 876 A1 discusses many different approaches. One group of the approaches, which includes, for example, chromium-plated nickel structures, spherical calotte structures having convex or convex and concave surface elements or granulated aluminum, tracks the effect various influences have on the micro-roughness of the surface of the print-substrate contacting element. In the approach provided by the technical teaching of German Patent Application No. 101 15 876 A1, materials are used which are known in the manufacturing of printing forms. With the assistance of a photocatalytic reaction, these materials can be brought into a strongly hydrophilic and, thus, ink-repellent state. Examples of such materials are oxides of titanium or oxides of zirconium.

One microstructured surface of a print substrate-contacting element, in particular of a back-pressure cylinder, having low surface energy, and thus low adhesion capacity for printing ink, can also be constituted of a plasma spray-applied aluminum oxide layer provided with a silicon coating.

Perfluoroorganyl groups, in particular perfluoroalkyl groups, (Teflon-type) have an even lower surface energy, and thus an even lower adhesion capacity for printing ink. For example, it is known from U.S. Pat. No. 6,325,490 B1 to provide surfaces of ink jet nozzles with Teflon-type coatings. Coatings are formed using organyl thiols (R—SH) to produce self-assembling monolayers, SAM. The thiols can be substituted with fluoroalkyl groups.

While, on the one hand, when working with a print substrate-contacting element, it is necessary to prevent printing ink from being deposited on the contacting location or surface of the element, on the other hand, it must be ensured that the print substrate contacted by the element does not slip. This aspect is not considered in the technical teaching of U.S. Pat. No. 6,325,490 B1 with respect to producing coatings using organyl thiols.

Generally, the described concepts for coating print substrate-contacting elements are relatively expensive. When an ink-repellent surface is worn, it is necessary to replace the surface, i.e., to remove or disassemble the worn print substrate-processing element from the print substrate-processing machine and to use a replacement element.

### SUMMARY OF THE INVENTION

An object of the present invention is to devise a print substrate-contacting element whose surface is ink-repellent, but has anti-slip properties with respect to the print substrate, and to provide a method for producing such a surface in a simple manner.

A print substrate-contacting element according to the present invention has an ink-repellent coating on a surface of a microstructured carrier, the ink-repellent coating including a derivative of an amphiphilic organic compound, whose polar region has an acidic character. The derivative of an amphiphilic organic compound is able to form a coating on the surface of the carrier without filling in or filling up its microstructure. In other words, by using the derivative of an amphiphilic organic compound, it is possible to undertake a nano-structuring of the surface of the microstructured carrier, without leveling the microstructure. The concept of the present invention is to combine the properties of a microstructured surface for fixing print substrates in position, with the properties of the ink-repellent coating (having nano-structuring action) provided by the derivatives in question.

The print substrate-contacting element may be a cylinder (preferably), a gripper, a gripper contact surface, a conveyor belt, a carrier roller, a transfer roller, a stop means, a guide or the like. On a microscopic scale (micrometer range), the microstructured carrier, which makes up a part of the print substrate-contacting element, may have a hilly or spherical calotte structure. On a microscopic scale as well, the microstructured carrier may have small peaks, which are (preferably) evenly or unevenly distributed in a plane that is smooth relatively thereto. The microstructure provides a print substrate resting on the surface with a smooth subsurface having a small contact area ratio, enabling it to rest in a slip-resistant manner on a few elevated points. The derivative of an amphiphilic organic compound may form a self-assembling monolayer (SAM) on the microstructured carrier. It is also possible to use a plurality of derivatives of an amphilic organic compound or a plurality of derivatives of a plurality of amphiphilic organic compounds, which, together, are also able to produce a self-assembling monolayer.

The derivative of an amphiphilic organic compound may also be a mono- or poly-substituted amphiphilic organic compound (having one or more different substituents). The amphiphilic organic compound may also be a surfactant compound. The amphiphilic organic compound may be an inorganic or organic acid substituted with an aliphatic or aromatic residue (nonpolar region), which has at least one element from the IV., V. or VI. main group of the periodic table, in particular carbon (C), phosphorus (P), sulfur (S), or nitrogen (N). The residue may be an unsubstituted or a substituted aliphatic compound or an unsubstituted or a substituted aromatic compound. The residue, the nonpolar region, may have, in particular, a carbon chain, the number of carbons being greater than or equal to 12 and less than or equal to 25. In representative specific embodiments of the reusable printing forme of the present invention, the amphiphilic organic compound, whose polar region has an acidic character, may be a hydroxamic acid derivative {R—C(O)—NH—OH} or a phosphonic acid derivative {R—P(O)—(OH)2}, in particular a derivative of the n-heptadecan-hydroxamic acid {CH3(CH2)16-C(O)—NH—OH} or a derivative of the n-octadecan-phosphonic acid {CH3(CH2)17-P(O)—(OH)2}. The derivatives of the amphiphilic organic compound may have substituents from the following group: fluorine (F), bromine (Br), chlorine (Cl), hydroxyl, benzyl, phenyl. In one advantageous specific embodiment, the derivative of an amphiphilic organic compound is substituted in its nonpolar region in such a way that it is both ink-repellent (oleophobic) as well as water-repellent (hydrophobic). In one preferred specific embodiment, the derivative of an amphiphilic organic compound is fluorinated in its nonpolar region.

In an advantageous design, the microstructured carrier of the print substrate-contacting element is metallic and has a natively oxidized surface. Preferably, the carrier has at least one substance from the group including titanium (Ti), zirconium (Zr), molybdenum (Mo), nickel (Ni), copper (Cu), aluminum (Al), chromium (Cr), iron (Fe), silver (Ar) and gold (Au). The carrier materials may be produced and microstructured using current industrial manufacturing methods. Long-chain alkane hydroxamic acids and alkane phosphonic acids produce self-assembling monolayers on natively oxidized surfaces, see, for example, J. P. Folkers et al. “Self-Assembled Monolayers of Long-Chain Hydroxamic Acids on the Native Oxides of Metals”, Langmuir 1995, vol. 11, pages 813-824. The 1995 Langmuir document, vol. 11, pages 813-824 by J. P. Folkers et al. describes, inter alia, the synthesis of a few hydroxamic acids, the preparation of natively oxidized surfaces as carriers or substrates, and the measurement of contact angles against water. The disclosure this 1995 Langmuir document, 11, 813-824 is incorporated by reference in this specification of the print substrate-contacting element according to the present invention.

A reliably reproducible performance characteristic is advantageously achieved with respect to print substrate guidance and depositing of printing ink on the surface of the print substrate-contacting element. Using hydroxamic acid derivatives or phosphonic acid derivatives, it is possible to produce reproducibly defined ink-repellent metal oxide surfaces, whose contact angles, measured against water, are greater than 90 degrees.

In one preferred specific embodiment, the print substrate-contacting element is a back-pressure cylinder or forms part of the top surface of a back-pressure cylinder.

The print substrate-contacting element of the present invention may be used in a print substrate-processing machine, in particular in a printing press. Therefore, a print substrate-processing machine according to the present invention is distinguished by at least one print substrate-contacting element. The print substrate-processing machine, in particular a printing press, may be sheet-processing or web-processing. A sheet-processing printing press, in particular a front-side and back-side printing press, may have a feeder, a number of print units, and a delivery unit. Typical print substrates include paper, paper board, cardboard, organic polymer film or the like. The print substrate may be in the form of a sheet or web. A printing press in accordance with the present invention is able to print using a direct or indirect planographic method (offset printing method).

In conjunction with the inventive idea, there is also a method for coating a surface of a microstructured carrier of a print substrate-contacting element. In other words, the inventive idea also includes providing a way to coat a print substrate-contacting element having a microstructured carrier so as to render it ink-repellent.

The coating method of the present invention is distinguished in that an amount of substance, which includes at least one derivative of an amphiphilic organic compound, whose polar region has an acidic character, is applied by treating the surface with an aqueous or alcoholic solution of the amount of substance.

In the method according to the present invention for coating a surface of a microstructured carrier of a print substrate-contacting element, the treated surface may be cleaned by an organic solvent, in particular an aqueous or alcoholic solution, preferably ethanol, in which non-adherent parts of the quantity of substance are soluble. Moreover, the treated surface may be dried using an anhydrous process gas, such as nitrogen or dry air.

In another embodiment of the method according to the present invention for coating a surface of a microstructured carrier of a print substrate-contacting element, the surface of the microstructured carrier is precleaned before being treated with the aqueous or alcoholic solution of the quantity of substance by wetting the surface with an organic, in particular alcoholic cleaning solvent. In yet another embodiment of the method, prior to treatment with the alcoholic solution of the quantity of substance, the surface may be conditioned by irradiating it, in particular, using infrared, visible, or ultraviolet light.

In one preferred specific embodiment, the method for coating a surface of a microstructured carrier of a print substrate-contacting element is implemented in a print substrate-processing machine, in particular in a printing press. The method according to the present invention devises a simple way to remedy manifestations of wear on the ink-repellent surface. The coating may be realized within the print substrate-processing machine.

In one especially advantageous, preferred specific embodiment, it is checked in the method according to the present invention whether the ink-repellent property of the print substrate-contacting element suffices or not, and, depending on the inspection result, a coating operation is carried out. If manifestations of wear degrade the ink-repellent properties or the print-substrate guidance properties, the surface of the microstructured carrier may be recoated.

The method according to the present invention renders possible the repeated application or renewal of a coating of at least one derivative of an amphiphilic organic compound whose polar region has an acidic character, in particular hydroxamic acid derivatives or phosphonic acid derivatives, on surfaces of microstructured carriers of print substrate-contacting elements.

### BRIEF DESCRIPTION OF THE DRAWINGS

Further advantages, advantageous specific embodiments and further refinements of the present invention are described on the basis of the following figures as well as their descriptions. In particular:

FIG. 1 shows an advantageous specific embodiment of the method according to the present invention for coating a print substrate-contacting element; and

FIG. 2 shows a schematic representation of a printing press having a back-pressure cylinder which is provided with an ink-repellent coating, as an advantageous specific embodiment of a print substrate-contacting element according to the present invention.

### DETAILED DESCRIPTION

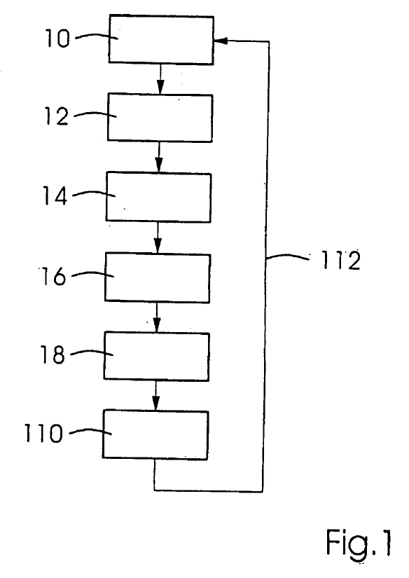

In a flow chart, FIG. 1 shows one advantageous specific embodiment of the method according to the present invention for coating a print substrate-contacting element, as may take place, in particular, within a print substrate-processing machine as well. In this specific embodiment, the surface of the microstructured carrier is a natively oxidized metal surface, in this connection, also referred to as a metal oxide surface. Without limiting universality with respect to the derivatives of amphiphilic organic compounds and with respect to the metal oxide surfaces, one advantageous specific embodiment of a method according to the present invention for coating on the basis of a natively oxidized titanium surface and on the basis of a derivative of the n-octadecan-phosphonic acid is elucidated exemplarily.

The metal oxide surface is first precleaned. A precleaning 10 may include the step of rinsing using acetone, ethanol, isopropanol, ethyl acetate, or another suitable organic solvent (also in aqueous or alcoholic solution). One purpose is, in particular, degreasing of the surface.

The precleaned metal oxide surface of the print substrate-contacting element is subsequently conditioned. A conditioning 12 is undertaken by irradiating the surface with light of a suitable wavelength, intensity, and duration of illumination for the subsequent coating step.

The application 14 of a quantity of substance, which includes at least one derivative of the n-octadecan-phosphonic acid, is carried out in the following manner: The titanium surface is wetted with a solution containing the above-named compounds in a suitable concentration, close to the limit of saturation, preferably in the concentration 1 m mol/l. The titanium surface is treated with a 1 mM ethanolic solution of the derivative of the n-octadecan-phosphonic acid (stearin phosphonic acid) at room temperature for the duration of about 5 minutes.

A cleaning 16 of the treated titanium surface is effected by rinsing using an organic solvent, an aqueous or alcoholic solution, such as acetone, ethanol (preferred), isopropanol, ethyl acetate or another suitable organic solvent, which removes the non-adherent parts of the quantity of substance from the n-octadecane-phosphonic acid derivative solution.

A drying 18 of the cleaned, treated titanium surface is fully carried out using an anhydrous, a so-called dry process gas, in this case nitrogen.

An inspection 110 as to whether the ink-repellent property of the print substrate-contacting element suffices or not may be performed directly at the surface of the microstructured carrier or indirectly at the surface of the print substrate. Should manifestations of wear occur or be ascertained in the ink-repellant coating, the coating operation may be repeated in its entirety or in part for the affected parts of the surface. The simple incremental steps of the method according to the present invention and its advantageous further embodiments enable a coating or recoating operation to be carried out in a print substrate-processing machine.

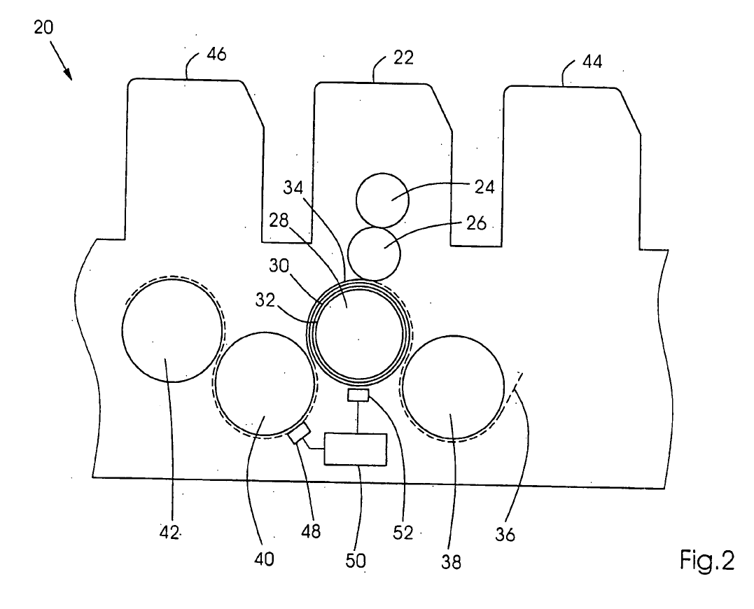

FIG. 2 is a schematic representation of a printing press having a back-pressure cylinder which is provided with an ink-repellent coating, as an advantageous specific embodiment of a print substrate-contacting element according to the present invention.

In a cutaway view of a print substrate-processing machine, here of printing press 20, a print unit 22 having a printing-form cylinder 24, a blanket cylinder 26, and a back-pressure cylinder 28 according to the present invention are shown. Back-pressure cylinder 28 has an ink-repellent coating 30 having at least one derivative of an amphiphilic organic compound, whose polar region has an acidic character, on a microstructured carrier 32. Print substrate 34, here in the form of a sheet, is moved through printing press 20 (print substrate-processing machine) along a path 36. In the process, print substrate 34 passes the printing nip formed by blanket cylinder 26 and back-pressure cylinder 28. Path 36 partially winds around a first upstream sheet-guide cylinder 38, a second downstream sheet-guide cylinder 40, and a third downstream sheet-guide cylinder 42. Printing press 20 has a print unit 44 situated upstream from print unit 22 and a print unit 46 situated downstream from print unit 22. They are not discussed in further detail in this description, but are designed comparably to print unit 22.

Without restricting the general configuration of a print substrate-processing machine 20 in accordance with the present invention, in the context of FIG. 2, print unit 22 is the first back-pressure unit of printing press 20. In other words, upstream print unit 46 and, optionally, other upstream print units (not shown here) of printing press 20 print on that side (front side) of print substrate 34 which comes into contact with the surface of back-pressure cylinder 28, while print unit 22 prints on the other side (back side) of print substrate 34. On path 36 partially winding around the individual cylinders, for adjacent cylinders, the front and back sides of print substrate 34 are alternately situated on the outside and inside, on the periphery of the cylinder carrying or guiding the print substrate, so that, for example, on the second, downstream sheet-guide cylinder 40, the back printing side of print substrate 34 is situated on the outside and is accessible for inspection purposes. For purposes of automatic, indirect inspection to determine whether the ink-repellent property of back-pressure cylinder 28 suffices or not, print unit 22 has a detection device 48, which may be used to optically examine whether the print image on print substrate 34 has been smudged or soiled. It is immediately evident to one skilled in the art that, alternatively thereto, a machine operator may also indirectly examine the print image by visually inspecting the same. The recorded measurement data are fed to an inspection device 50 in which a setpoint-actual value comparison is carried out, so that a decision as to whether a complete or partial recoating is needed or not may be made, as soon as a threshold value of one measure of the deviation of setpoint and actual values is exceeded. Print unit 22 has a coating device 52, which may be used to fully or partially coat microstructured carrier 32 of back-pressure cylinder 28, without having to remove back-pressure cylinder 28 from print unit 22. The individual points or positions on the two-dimensional surface of back-pressure cylinder 28 are able to be reached because of the rotation of the cylinder about its axis of symmetry and the translational motion of coating device 52 in parallel to the axis of symmetry of the cylinder. Coating device 52 is designed to be able to implement the individual steps of the method according to the present invention or of its advantageous further embodiments. Coating device 52 may be controlled by the machine operator if needed, or inspection device 50 drives coating device 52 and back-pressure cylinder 28 to positions where a recoating appears necessary.

In summary, it can be ascertained that, by applying the coating method according to the present invention, one is easily able to produce an ink-repellent surface of a print substrate-contacting element having reliably reproducible performance characteristics with respect to print substrate guidance, as well as to restore a worn, ink-repellent surface. By applying the above, more closely described derivatives of an amphiphilic organic compound, whose polar region has an acidic character, within a time period of a few minutes, a strong enough ink repellency is able to be attained for a back-pressure surface, i.e., for the surface of a back-pressure cylinder, for use in a back-pressure offset printing process. The cycle in the described specific embodiment of the method according to the present invention in accordance with FIG. 1 is able to be carried out within 30 minutes. The method according to the present invention makes it possible to adjust the ink repellency of metal oxide surfaces, as are manufactured using current industrial production methods. The worn areas of the ink-repellent surface may be repeatedly restored and, quite beneficially, within a print substrate-processing machine.

### REFERENCE SYMBOL LIST

10 precleaning step
12 conditioning step
14 application step
16 cleaning step
18 drying step
110 inspection step
112 repeating of the coating operation
20 print substrate-processing machine
22 print unit
24 printing forme cylinder
26 blanket cylinder
28 back-pressure cylinder
30 ink-repellent coating
32 carrier
34 print substrate
36 path of the print substrate through the print substrate-processing machine
38 first sheet-guide cylinder
40 second sheet-guide cylinder
42 third sheet-guide cylinder
44 upstream print unit
46 downstream print unit
48 detection device
50 inspection device
52 coating device

What is claimed is:

1. An offset printing press comprising:
a print substrate-contacting element having a micro-structured carrier having a surface;
an ink-repellent coating on the surface of the micro-structured carrier, the ink repellent coating including a derivative of an amphiphilic organic compound having a polar region with an acidic character, the derivative of an amphiphilic organic compound being a hydroxamic acid derivative or a phosphonic acid derivative.

2. The offset printing press as recited in claim 1 wherein the carrier is metallic and has a natively oxidized surface.

3. The offset printing press as recited in claim 1 wherein the carrier has at least one substance selected from the group consisting of titanium, zirconium, molybdenum, nickel, copper, aluminum, chromium, iron, silver and gold.

4. The offset printing press as recited in claim 1 wherein the hydroxamic acid derivative is a derivative of n-heptadecan-hydroxamic acid or the phosphoric acid derivative is a derivative of n-octadecan-phosphonic acid.

5. The offset printing press as recited in claim 1 wherein the derivative of an amphiphilic compound is substituted in a nonpolar region so the nonpolar region is both ink-repellent and water-repellent.

6. The offset printing press as recited in claim 1 wherein the derivative of an amphiphilic organic compound is fluorinated in a nonpolar region.

7. The offset printing press as recited in claim 1 wherein the derivative of an amphiphilic compound forms a self-assembling monolayer on the micro-structured carrier.

8. The offset printing press as recited in claim 1 wherein the print substrate-contacting element is a back-pressure cylinder or a part of the surface thereof.

9. The offset printing press as recited in claim 1 wherein the print substrate-contacting element is selected from the group consisting of a gripper, a gripper contact surface, a conveyor belt, a carrier roller, a transfer roller, a stop and a guide.

10. A method for coating a surface of a microstructured carrier of a print substrate-contacting element, the method comprising the step of:
applying an amount of a substance including at least one derivative of an amphiphilic organic compound having a polar region with an acidic character by treating the surface with an aqueous or alcoholic solution of the amount of the substance.

11. The method as recited in claim 10 further comprising cleaning the treated surface with an organic solvent, non-adherent parts of the quantity of substance being soluble in the organic colvent.

12. The method as recited in claim 10 further comprising drying the treated surface using an anhydrous process gas.

13. The method as recited in claim 10 further comprising precleaning the surface of the microstructured carrier prior to the treating with the aqueous or alcoholic solution of the quantity of substance by wetting the surface with an organic solvent.

14. The method as recited in claim 10 further comprising conditioning the surface prior to the treating with the alcoholic solution of the quantity of substance by irradiating the surface.

15. A method for operating a print substrate-processing machine comprising the step of:
coating a surface of a microstructured carrier of a print substrate-contacting element of the machine, the coating step including applying an amount of a substance including at least one derivative of an amphiphilic organic compound having a polar region with an acidic character by treating the surface with an aqueous or alcoholic solution of the amount of the substance.

16. The method as recited in claim 15 further comprising contacting a print substrate with the surface.

17. The method as recited in claim 15 further comprising inspecting whether the printing substrate contacting element is ink repellant or not.
